(19) United States
(12) Patent Application Publication
(10) Pub. No.: US 2025/0145156 A1
(43) Pub. Date: May 8, 2025

(54) DRIVING ASSISTANCE DEVICE AND DRIVING ASSISTANCE METHOD

(71) Applicant: HONDA MOTOR CO., LTD., Tokyo (JP)

(72) Inventors: Kyosuke Inada, Tokyo (JP); Masaki Nakagawara, Tokyo (JP)

(73) Assignee: HONDA MOTOR CO., LTD., Tokyo (JP)

(21) Appl. No.: 18/929,723

(22) Filed: Oct. 29, 2024

(30) Foreign Application Priority Data
Nov. 8, 2023 (JP) 2023-191113

(51) Int. Cl. B60W 30/14; B60W 10/06; B60W 10/08; B60W 10/18; B60W 30/18; B60W 60/00

(52) U.S. Cl. CPC B60W 30/143; B60W 10/06; B60W 10/08; B60W 10/18; B60W 30/18163; B60W 60/001; B60W 2520/14; B60W 2520/18; B60W 2554/802; B60W 2554/804; B60W 2720/106

(57) ABSTRACT

A driving assistance device comprises: an external environment detection sensor of a vehicle; and a controller configured to control a drive source of the vehicle. The controller controls the drive source so as to change acceleration of the vehicle on the basis of relative information including at least any one of an arrival time, a distance, or a relative speed with respect to a predetermined position ahead or another vehicle ahead in a self-vehicle traveling lane in which the vehicle travels, and a traveling status in another traveling lane as a merging destination on the basis of information of the external environment detection sensor.

### CROSS-REFERENCE TO RELATED APPLICATION(S)

This application claims priority to and the benefit of Japanese Patent Application No. 2023-191113 filed on Nov. 8, 2023, the entire disclosure of which is incorporated herein by reference.

### BACKGROUND OF THE INVENTION

### Field of the Invention

The present invention relates to a driving assistance device and a driving assistance method.

### Description of the Related Art

Japanese Patent Laid-Open No. 2013-107431 discloses a technology of changing a lane between a preceding vehicle and a following vehicle that travel in an adjacent lane when changing a lane from a lane in which a self-vehicle travels to the adjacent lane.

However, in a traveling environment in which the traveling lane of the self-vehicle merges with another traveling lane, it is necessary to finish merging with another traveling lane before a front end position of the traveling lane of the self-vehicle. In a two-wheeled vehicle having high power performance of acceleration/deceleration, a degree of freedom of acceleration control increases, such as merging at a position on a front side of the preceding vehicle that travels in another traveling lane or merging at a position on a rear side of the preceding vehicle, therefore, acceleration control of the vehicle according to the traveling environment of the self-vehicle and a situation of the lane as a merging destination is required.

In view of the above problem, the present invention provides a driving assistance technology capable of changing acceleration of a vehicle according to a mergeable position determined according to a situation of another traveling lane as a merging destination in a traveling environment in which a traveling lane of a self-vehicle merges with another traveling lane.

### SUMMARY OF THE INVENTION

According to one aspect of the present invention, there is provided a driving assistance device comprising: an external environment detection sensor of a vehicle; and a controller configured to control a drive source of the vehicle, wherein the controller controls the drive source so as to change acceleration of the vehicle on the basis of relative information including at least any one of an arrival time, a distance, or a relative speed with respect to a predetermined position ahead or another vehicle ahead in a self-vehicle traveling lane in which the vehicle travels, and a traveling status in another traveling lane as a merging destination on the basis of information of the external environment detection sensor.

According to the present invention, in a traveling environment in which a traveling lane of a self-vehicle merges with another traveling lane, acceleration of the vehicle can be changed according to a mergeable position determined according to a situation of another traveling lane as a merging destination.

### BRIEF DESCRIPTION OF THE DRAWINGS

FIG. 1 is a side view on a right side of a vehicle according to an embodiment;

FIG. 2 is a front view of the vehicle according to the embodiment;

FIG. 3 is a diagram illustrating an arrangement example of an external environment detection sensor;

FIG. 4 is a block diagram of a driving assistance device according to the embodiment;

FIG. 5 is a diagram illustrating a flow of processing of the driving assistance device according to the embodiment;

FIG. 6 is a diagram illustrating a specific example 1 of the processing of the driving assistance device; and

FIG. 7 is a diagram illustrating a specific example 2 of the processing of the driving assistance device.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

Information indicating a relative relationship between a vehicle (self-vehicle) and another vehicle (a preceding vehicle or a following vehicle) may include, for example, an inter-vehicle time, an inter-vehicle distance, or a relative speed between the vehicle and another vehicle. In the present embodiment, these pieces of information are collectively referred to as “relative information”. In the embodiment described below, the description is made using the inter-vehicle time as an example of the relative information, but the present invention is not limited to the inter-vehicle time, and can be similarly applied to the inter-vehicle distance, the relative speed and the like.

Hereinafter, a vehicle according to an embodiment of the present invention will be described with reference to the drawings. In each drawing, arrows X, Y, and Z indicate directions orthogonal to one another, in which an X direction indicates a front-and-rear direction of a vehicle, a Y direction indicates a vehicle width direction (a left-and-right direction) of the vehicle, and a Z direction indicates an up-and-down direction. Left and right of the vehicle are left and right when viewed in a forward direction. Hereinafter, front or rear of the vehicle in the front-and-rear direction may be simply referred to as front or rear. An inside or an outside of the vehicle in the vehicle width direction (the left-and-right direction) may be simply referred to as an inside or an outside.

### <Outline of Vehicle>

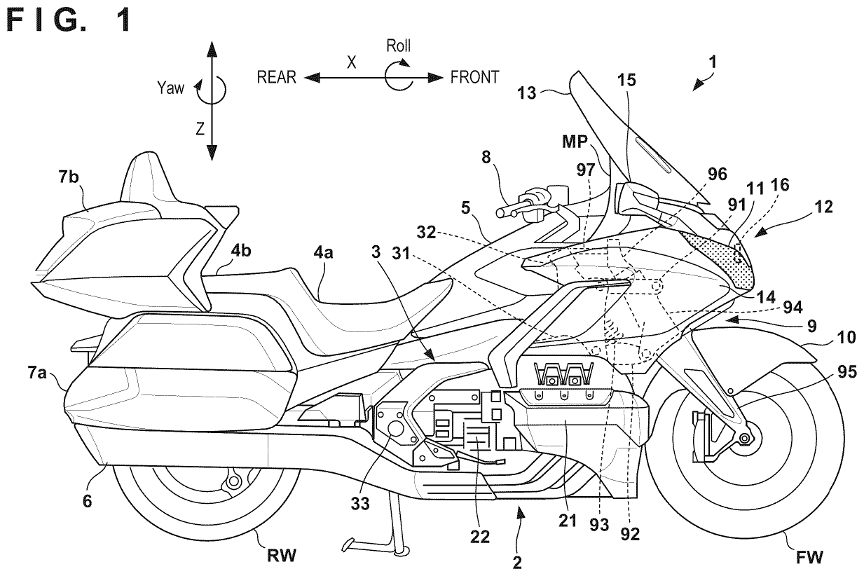

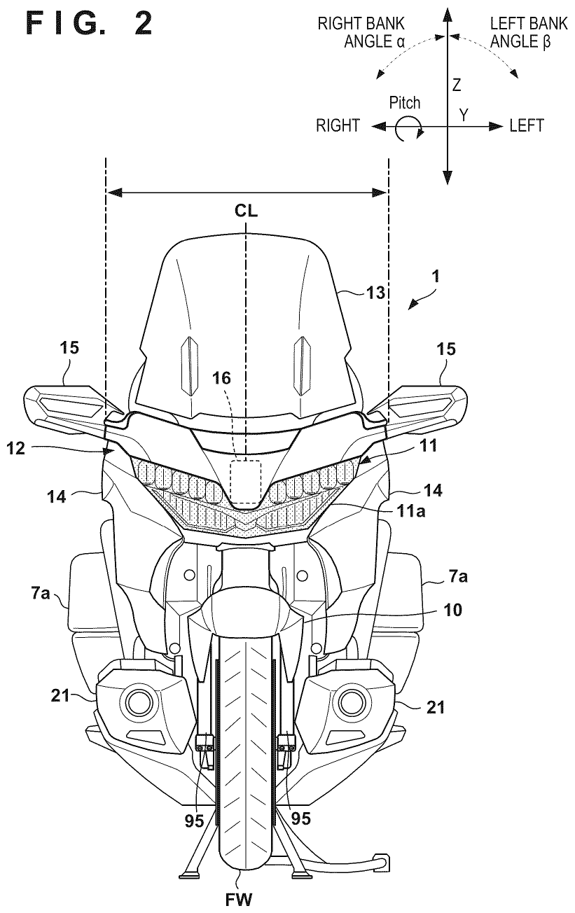

FIG. 1 is a right side view of a vehicle 1 according to an embodiment of the present invention, and FIG. 2 is a front view of the vehicle 1. Although the vehicle 1 illustrated in FIGS. 1 and 2 is a straddled type two-wheeled vehicle, the present invention is also applicable to other types of two-wheeled vehicles. The present invention is also applicable to an electric vehicle using a motor as a drive source in addition to a vehicle using an internal combustion engine as a drive source.

The vehicle 1 includes a power unit 2 between a front wheel FW and a rear wheel RW. In the present embodiment, the power unit 2 includes a drive source 21 and a transmission 22. Driving force of the transmission 22 is transmitted to the rear wheel RW through a power transmission mechanism not illustrated to rotate the rear wheel RW.

The power unit 2 is supported by a vehicle body frame 3. The vehicle body frame 3 includes a pair of left and right main frames 31 extending in an X direction. A fuel tank 5 and an air cleaner box (not illustrated) are disposed above the main frames 31. A meter panel MP that displays various types of information to a rider is provided in front of the fuel tank 5.

A head pipe 32, which rotatably supports a steering shaft (not illustrated) rotated by a handlebar 8, is provided at a front end portion of the main frame 31. At a rear end portion of the main frames 31, a pair of left and right pivot plates 33 are provided. Lower end portions of the pivot plates 33 and front end portions of the main frames 31 are connected by a pair of left and right lower arms (not illustrated), and the power unit 2 is supported by the main frames 31 and the lower arms. At the rear end portions of the main frames 31, a pair of left and right seat rails extending rearward are also provided, and the seat rails support a seat 4a on which a rider is seated, a seat 4b on which a passenger is seated, a rear trunk 7b and the like. The rear end portions of the seat rails and the pivot plates 33 are connected by a pair of left and right sub frames, respectively.

A front end portion of a rear swing arm (not illustrated) extending in a front-and-rear direction is swingably supported by the pivot plates 33. The rear swing arm is swingable in an up-and-down direction, and the rear wheel RW is supported at a rear end portion thereof. An exhaust muffler 6 that muffles exhaust of the drive source 21 extends in the X direction on a lower lateral side of the rear wheel RW. Left and right saddle backs 7a are provided on upper lateral side of the rear wheel RW.

At the front end portion of the main frame 31, a front suspension mechanism 9, which supports the front wheel FW, is formed. The front suspension mechanism 9 includes an upper link 91, a lower link 92, a fork support body 93, a cushion unit 94, and a pair of left and right front forks 95.

The upper link 91 and the lower link 92 are disposed at the front end portion of the main frame 31 to be spaced apart from each other in the up-and-down direction. Rear end portions of the upper link 91 and the lower link 92 and front end portions of the upper link 91 and the lower link 92 are swingably coupled with the fork support body 93. The upper link 91 and the lower link 92 extend in the front-and-rear direction and are disposed substantially in parallel.

The cushion unit 94 has a structure in which a shock absorber is inserted into a coil spring, and an upper end portion thereof is swingably supported by the main frame 31. A lower end portion of the cushion unit 94 is swingably supported by the lower link 92. The fork support body 93 has a tubular shape and is inclined rearward.

A steering shaft 96 is supported by the fork support body 93 so as to be rotatable about an axis thereof. The steering shaft 96 includes a shaft portion (not illustrated), which is inserted into the fork support body 93. A bridge (not illustrated) is provided at a lower end portion of the steering shaft 96, and the pair of left and right front forks 95 are supported by the bridge. The front wheel FW is rotatably supported by the front fork 95. An upper end portion of the steering shaft 96 is coupled with the steering shaft (not illustrated) rotated by the handlebar 8 through a link 97. The steering shaft 96 is rotated by steering of the handlebar 8, and the front wheel FW is steered. An upper portion of the front wheel FW is covered with a fender 10, and the fender 10 is supported by the front forks 95.

In a front portion of the vehicle 1, a headlight unit 11 that emits light ahead of the vehicle 1 is disposed. The front portion of the vehicle 1 is covered with a front cover 12, and side portions of a front side of the vehicle 1 are covered with a pair of left and right side covers 14. A screen 13 is disposed above the front cover 12. The screen 13 is a windshield that reduces a wind pressure to be received by a rider during traveling, and is made of, for example, a transparent resin member. A pair of left and right side mirror units 15 are disposed on lateral sides of the front cover 12. In the side mirror units 15, side mirrors for the rider to visually recognize behind are supported.

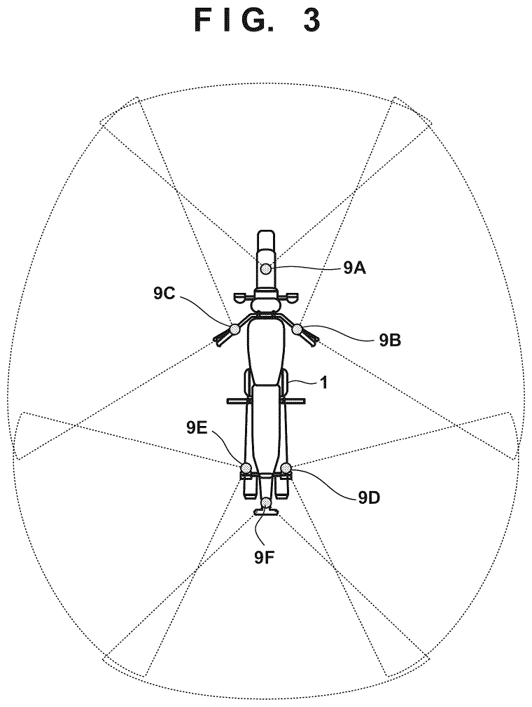

FIG. 3 is a diagram illustrating an arrangement example of an external environment detection sensor. The external environment detection sensor is a sensor that detects another vehicle around the vehicle 1 (self-vehicle) and the number of traveling lanes of a road on which the vehicle 1 travels during the travel of the vehicle 1. The external environment detection sensor may be, for example, a camera including a millimeter wave radar, an ultrasonic sensor, a CCD/CMOS image sensor and the like, and a ranging device such as a light detection and ranging (LiDAR). In the present embodiment, as an example, external environment detection sensors 9A to 9F set the front, left and right, and rear of the vehicle 1 as detection ranges thereof, and detects another vehicle traveling ahead and another vehicle approaching the vehicle 1 (self-vehicle) from behind. The external environment detection sensors 9A to 9F detect the number of traveling lanes on the road on which the vehicle 1 travels. In a case where an obstacle is detected ahead of the vehicle 1 by the external environment detection sensors 9A to 9F, for example, a display for calling the rider's attention can be made on the meter panel MP.

As arrangement positions of the external environment detection sensors 9A to 9F, for example, any of the front portion, side portion, and rear portion of the vehicle 1 can be arrangement sites of the sensors (9A to 9F) as illustrated in FIG. 3. External environment detection information of the vehicle 1 (self-vehicle) detected by the external environment detection sensors 9A to 9F is input to a control device 410 (controller) of a driving assistance device 400. Note that, FIG. 3 illustrates an example in which three external environment detection sensors are arranged on the front side and three external environment detection sensors are arranged on the rear side of the vehicle 1 as the external environment detection sensors 9A to 9F; however, it is not limited to this example, the positions are not limited these positions, and the number of external environment detection sensors to be arranged is optional as long as the information around the vehicle 1 can be detected.

### <Configuration of Driving Assistance Device>

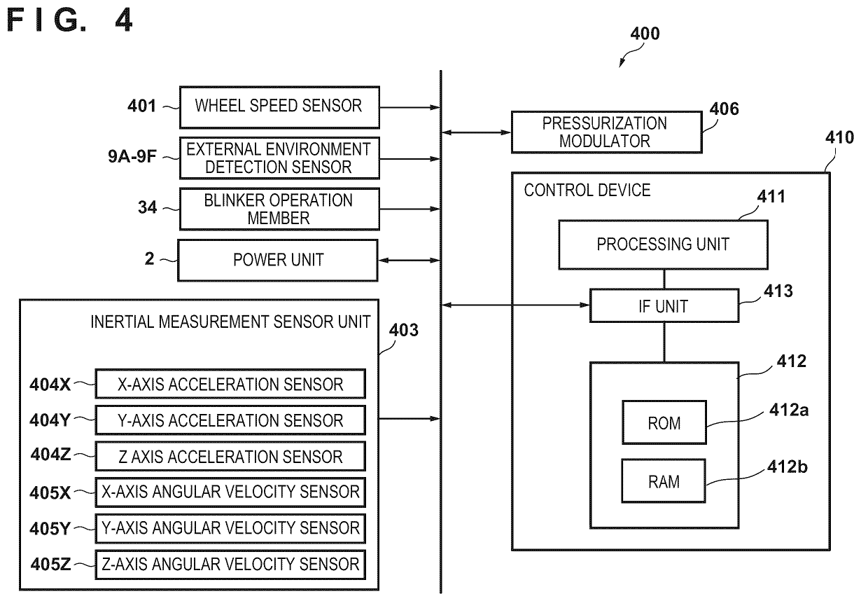

FIG. 4 is a diagram illustrating a configuration of the driving assistance device 400 according to the embodiment. The driving assistance device 400 includes the external environment detection sensors 9A to 9F that detect an external environment of the vehicle 1, a wheel speed sensor 401 that detects a speed of the vehicle 1, an inertial measurement sensor 403 that measures a posture of the vehicle 1, and the control device 410 (controller) that controls the power unit 2 including the drive source 21 of the vehicle 1 and a pressurization modulator 406 using information acquired from the external environment detection sensors 9A to 9F, the wheel speed sensor 401, and the inertial measurement sensor 403. The control device 410 controls the drive source 21 to change acceleration of the vehicle 1 on the basis of relative information including at least any one of an arrival time, a distance, or a relative speed with respect to a predetermined position ahead or another vehicle ahead in a self-vehicle traveling lane in which the vehicle 1 travels, and a traveling status in another traveling lane as a merging destination on the basis of the information of the external environment detection sensors 9A to 9F. The vehicle 1 of the present embodiment includes the driving assistance device 400. In a case of performing acceleration control, the control device 410 generates an acceleration control signal, and controls the drive source 21 on the basis of the generated acceleration control signal to accelerate the vehicle 1. In a case of performing deceleration control, the control device 410 generates a deceleration control signal, and controls the pressurization modulator 406 on the basis of the generated deceleration control signal to decelerate the vehicle 1.

The wheel speed sensor 401 is provided, for example, on the front wheel FW and the rear wheel RW, and detects the vehicle speed corresponding to detection values of the rotation speeds of the front wheel FW and the rear wheel RW. The wheel speed sensor 401 includes, for example, a rotation speed sensor such as a rotary encoder that outputs a detection signal corresponding to the rotation speed of the front wheel FW of the vehicle 1. In this case, the wheel speed corresponding to the detection value of the rotation speed of the front wheel FW is acquired as detection information of the vehicle speed. The detection information of the vehicle speed detected by the wheel speed sensor 401 is input to the control device 410.

The inertial measurement sensor unit 403 (inertial measurement unit: IMU, hereinafter, also referred to as an inertial measurement sensor) detects acceleration and an angular velocity in the X, Y, and Z directions generated in the vehicle 1. The inertial measurement sensor unit 403 is a sensor unit capable of detecting a behavior of the vehicle 1 by detecting the acceleration and angular velocity generated in the vehicle 1. The inertial measurement sensor unit 403 can be disposed at any appropriate position of the vehicle 1, for example, in the vicinity of the gravity center of the vehicle 1. The inertial measurement sensor unit 403 includes an X-axis acceleration sensor 404X that detects translational acceleration (X-axis acceleration) in the X-axis direction (front-and-rear direction of the vehicle 1), a Y-axis acceleration sensor 404Y that detects translational acceleration (Y-axis acceleration) in the Y-axis direction (left-and-right direction of the vehicle 1), and a Z-axis acceleration sensor 404Z that detects translational acceleration (Z-axis acceleration) in the Z-axis direction (up-and-down direction of the vehicle 1) as sensors that detect the translational acceleration.

The inertial measurement sensor unit 403 also includes an X-axis angular velocity sensor 405X that detects an angular velocity in a direction around the X axis (X-axis angular velocity), a Y-axis angular velocity sensor 405Y that detects an angular velocity in a direction around the Y axis (Y-axis angular velocity), and a Z-axis angular velocity sensor 405Z that detects an angular velocity in a direction around the Z axis (Z-axis angular velocity) as sensors that detect the angular velocity. The acceleration and angular velocity in the X, Y, and Z directions detected by the inertial measurement sensor unit 403 are input to the control device 410. The control device 410 can acquire information indicating a yaw rate and a roll rate by combining information of each sensor of the inertial measurement sensor unit 403, and can obtain a change in the posture of the vehicle 1 during traveling. Here, the yaw rate is a change amount (change rate) of a yaw angle per unit time, and the roll rate is a change amount (change rate) of a roll angle per unit time.

The driving assistance device 400 includes a processing unit 411 configured with a processor such as a CPU, a storage unit 412, and an interface unit 413 (IF unit). The storage unit 412 includes a RAM 412b that stores sequential calculation results regarding driving assistance control, detection information detected by various sensors and the like, and a storage unit (ROM 412a) that stores various driving assistance control programs.

The processing unit 411 (processor) develops the driving assistance control program stored in the storage unit (ROM 412a) on the RAM 412b, and executes signal processing from various sensors, determination processing and arithmetic processing in the control device 410, and generation of control signals for controlling various devices forming the vehicle 1.

The interface unit 413 (IF unit) transmits and receives signals between various devices forming the vehicle 1 including the wheel speed sensor 401, the external environment detection sensors 9A to 9F, and the inertial measurement sensor unit 403, and the control device 410. The control device 410 includes an electronic control unit (ECU), and is mounted at any appropriate position of the vehicle 1. Note that, the control device 410 may include a plurality of electronic control units capable of communicating with each other.

The driving assistance device 400 performs at least a part of a driving operation in the vehicle 1 in place of a driver (rider). The driving assistance device 400 according to the present embodiment performs adaptive cruise control (ACC) for controlling the drive source 21 and a braking device so as to cause the vehicle 1 to follow a preceding vehicle traveling ahead of the vehicle 1 (self-vehicle). That is, in the ACC, the driving assistance device 400 performs acceleration control of increasing the acceleration of the vehicle 1 or braking control of decreasing the speed and acceleration instead of the operation of the rider. In the ACC, the driving assistance device 400 performs the acceleration control or the braking control in such a manner that an inter-vehicle time between the vehicle 1 and the preceding vehicle is maintained to a predetermined time, and an inter-vehicle distance between the preceding vehicle and the vehicle 1 is adjusted in such a manner that the inter-vehicle time becomes a predetermined value (for example, N1 seconds or the like).

When merging from the traveling lane in which the vehicle 1 travels to another traveling lane, the driving assistance device 400 obtains the inter-vehicle time with respect to the preceding vehicle on the basis of the position and speed of the preceding vehicle traveling in another traveling lane and the speed of the vehicle 1 (self-vehicle), and determines a mergeable position (candidate position) on the other traveling lane in a state in which a predetermined inter-vehicle time (for example, N1 seconds or the like) is maintained. In order to cause the self-vehicle to merge at a position based on the determination result, the driving assistance device 400 performs the acceleration control instead of the operation of the rider.

Similarly, the driving assistance device 400 performs the acceleration control or the braking control in such a manner that an inter-vehicle time between the vehicle 1 (self-vehicle) and a following vehicle that travels in a main lane is maintained to a predetermined time, and an inter-vehicle distance between the following vehicle and the vehicle 1 is adjusted in such a manner that the inter-vehicle time becomes a predetermined value (for example, N2 seconds or the like). In a case where there is the following vehicle approaching from behind at the time of merging, the driving assistance device determines a mergeable position (candidate position) in a state in which a predetermined inter-vehicle time with respect to the following vehicle (for example, N2 seconds or the like) is maintained.

The inter-vehicle time with respect to the preceding vehicle and the inter-vehicle time with respect to the following vehicle are preferably set to different times. For example, in a case of moving (merging) from the self-vehicle traveling lane to another traveling lane at a higher speed, in consideration of a time required for merging of the self-vehicle, it is possible to adjust the inter-vehicle time to a predetermined value by adjusting the speed of the self-vehicle with respect to the preceding vehicle that travels in another lane with which this merges. In contrast, regarding the following vehicle, in consideration of a time required for the self-vehicle to change the lane, there might be a case where the following vehicle that travels in another lane with which this merges approaches to a distance shorter than the inter-vehicle time of a predetermined value. Therefore, the inter-vehicle time with respect to the following vehicle might be set longer than the inter-vehicle time with respect to the preceding vehicle (N2>N1).

### Specific Example 1 of Driving Assistance Control

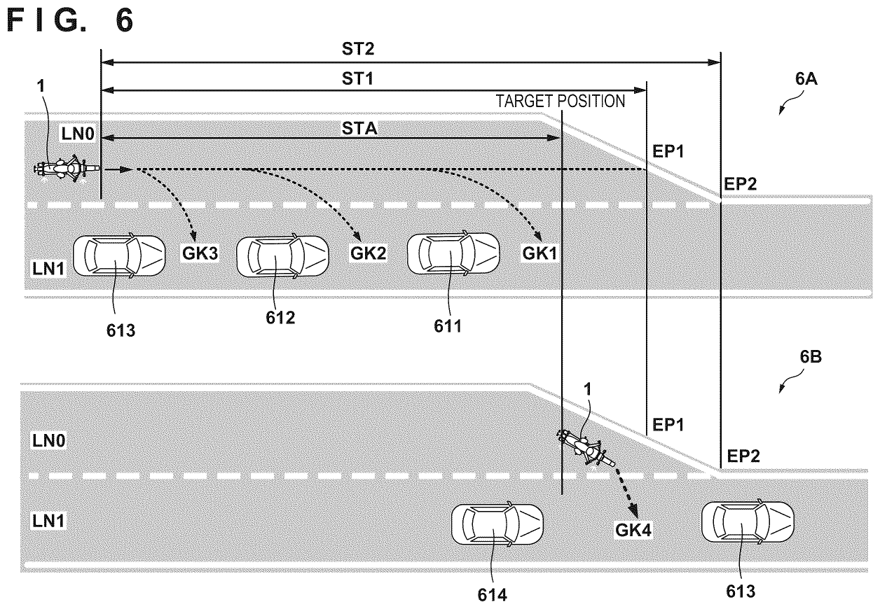

6A of FIG. 6 is a diagram illustrating a specific example 1 of processing of the driving assistance device 400 according to the embodiment. In the example illustrated in 6A of FIG. 6, as a traveling environment of the vehicle 1, a road in which a traveling lane (self-vehicle traveling lane LN0) in which the vehicle 1 (self-vehicle) travels merges with another traveling lane LN1 will be described as an example.

In 6A of FIG. 6, the vehicle 1 travels in the self-vehicle traveling lane LN0 at a predetermined vehicle speed set by the ACC, and the vehicle 1 is in a state of merging from the self-vehicle traveling lane LN0 with another traveling lane LN1. In another traveling lane LN1, a preceding vehicle 611 (first preceding vehicle), a preceding vehicle 612 (second preceding vehicle), and a preceding vehicle 613 (third preceding vehicle) located ahead of the vehicle 1 travel. In the present embodiment, the self-vehicle traveling lane LN0 is also referred to as a merging lane, and another traveling lane LN1 is also referred to as a main traveling lane.

The control device 410 determines whether the self-vehicle traveling lane LN0 in which the vehicle 1 travels is the merging lane that merges with another traveling lane LN1 on the basis of the information of the external environment detection sensors 9A to 9F. In a case where the self-vehicle traveling lane LN0 is the merging lane, the control device 410 acquires (extracts) a predetermined characteristic portion in the self-vehicle traveling lane LN0 on the basis of the information of the external environment detection sensors 9A to 9F. For example, the predetermined characteristic portion in the self-vehicle traveling lane LN0 may be acquired (extracted) by performing image processing on a camera image acquired as the information of the external environment detection sensors 9A to 9F, or acquired (extracted) by performing processing on a sensor signal.

The control device 410 acquires (extracts) a wall surface EP1 (front wall 650) of the self-vehicle traveling lane LN0 located ahead of the vehicle 1 as an example of the predetermined characteristic portion of the self-vehicle traveling lane LN0 on the basis of the information of the external environment detection sensors 9A to 9F, and specifies a relative position with respect to the vehicle 1. Then, the control device 410 sets an inter-vehicle time ST1 using the vehicle speed based on the information of the wheel speed sensor 401 and the position of the wall surface EP1 (front wall 650).

In a case where the self-vehicle traveling lane LN0 is the merging lane, the control device 410 sets a target position at which the merging of the vehicle 1 from the self-vehicle traveling lane LN0 to another traveling lane LN1 is finished. This target position might be set on the basis of the inter-vehicle time (for example, STA or the like) based on a structure of the self-vehicle traveling lane LN0. The target position indicates a limit position of the merging before arriving at which the merging is finished.

The target position can be set by various methods. An upper limit of the target position is a position shorter than the inter-vehicle time (ST1), and in order to avoid merging in a tight state, it is preferable to adjust the target position so that a predetermined margin is provided with respect to the inter-vehicle time ST1. The control device 410 may set an adjusted inter-vehicle time STA shorter than the inter-vehicle time ST1 using an adjustment parameter (0<α<1) providing the predetermined margin with respect to the inter-vehicle time ST1. For example, the control device 410 can acquire the adjusted inter-vehicle time STA by multiplying the inter-vehicle time ST1 by an adjustment parameter α1. Then, the control device 410 may acquire a position (target position) corresponding to the adjusted inter-vehicle time STA as the limit position of the merging. The target position can be set to any position by variously changing the adjustment parameter α.

Note that, the setting of the inter-vehicle time ST1 based on the structure (for example, wall surface EP1 (front wall 650)) of the self-vehicle traveling lane LN0 is illustrative, and is not limited to this example. For example, the control device 410 may acquire (extract) a terminal end EP2 of the self-vehicle traveling lane LN0 at which the self-vehicle traveling lane LN0 intersects with another traveling lane LN1 on the basis of the information of the external environment detection sensors 9A to 9F and specify a relative position with respect to the vehicle 1 as the predetermined characteristic portion in the self-vehicle traveling lane LN0.

Then, the control device 410 may set an inter-vehicle time ST2 using the vehicle speed based on the information of the wheel speed sensor 401 and the position of the terminal end EP2. The control device 410 may set the adjusted inter-vehicle time STA shorter than the inter-vehicle time ST2 using an adjustment parameter (0<α<1) indicating a predetermined margin with respect to the inter-vehicle time ST2. For example, the control device 410 can acquire the adjusted inter-vehicle time STA by multiplying the inter-vehicle time ST2 by an adjustment parameter α2.

The control device 410 acquires the inter-vehicle time regarding the preceding vehicle (for example, 611, 612) that travels in another traveling lane LN1 and the speed of the vehicle 1 on the basis of the information of the external environment detection sensors 9A to 9F and the wheel speed sensor 401, and acquires the candidate position at which the vehicle 1 can merge before arriving at a predetermined target position in a state in which a predetermined inter-vehicle time with respect to the preceding vehicle is maintained in another traveling lane LN1. In a case where there is one candidate position at which the vehicle 1 can merge, the control device 410 controls the drive source 21 to accelerate the vehicle 1 according to the candidate position.

In another traveling lane LN1, there is a case where there is a plurality of candidate positions at which the vehicle 1 can merge before arriving at the predetermined target position. For example, a first candidate position GK1 illustrated in 6A of FIG. 6 is a front position of the preceding vehicle 611 (first preceding vehicle). A second candidate position GK2 is an intermediate position between the preceding vehicle 611 (first preceding vehicle) and the preceding vehicle 612 (second preceding vehicle). A third candidate position GK3 is an intermediate position between the preceding vehicle 612 (second preceding vehicle) and the preceding vehicle 613 (third preceding vehicle).

In a case where a plurality of candidate positions is set, the control device 410 selects any one candidate position out of the plurality of candidate positions on the basis of a predetermined priority order, and controls the drive source 21 to accelerate the vehicle 1 according to the selected candidate position. A predetermined priority order can be optionally set and stored in the storage unit 412. For example, in a case where the plurality of candidate positions is set, the priority order can be set in order of proximity to a predetermined target position. For example, GK1 may be set to a first priority order, GK2 may be set to a second priority order, and GK3 may be set to a third priority order. Alternatively, a priority order of the intermediate position between a plurality preceding vehicles 611 and 612 may be set high. For example, GK2 may be set to the first priority order, GK1 may be set to the second priority order, and GK3 may be set to the third priority order.

The control device 410 controls the drive source 21 to accelerate the vehicle 1 according to the candidate position in a case where a blinker operation is input and a change in posture of the vehicle 1 that merges from the self-vehicle traveling lane LN0 of the vehicle 1 with another traveling lane LN1 is measured exceeding a threshold on the basis of the information of the inertial measurement sensor unit 403. Here, the information indicating the change in the posture of the vehicle 1 includes the yaw rate or roll rate of the vehicle 1 acquired on the basis of the measurement result of the inertial measurement sensor unit 403. The control device 410 controls the drive source 21 to accelerate the vehicle 1 in a case where the blinker operation is input and the yaw rate or roll rate exceeds a threshold.

The control device 410 controls the drive source 21 by changing setting of the acceleration of the vehicle according to the inter-vehicle time. The control device 410 compares the inter-vehicle time of the preceding vehicle with a predetermined time, and sets the acceleration in a case where the inter-vehicle time is shorter than the predetermined time lower than the acceleration set in a case where the inter-vehicle time is longer than the predetermined time.

In the example in 6A of FIG. 6, the inter-vehicle time corresponding to the first candidate position GK1 is set to ST_GK1, and the acceleration for merging at the first candidate position GK1 is set to a_GK1. The inter-vehicle time corresponding to the second candidate position GK2 is set to ST_GK2, and the acceleration for merging at the second candidate position GK2 is set to a GK2. The inter-vehicle time corresponding to the third candidate position GK3 is set to ST_GK3, and the acceleration for merging at the third candidate position GK3 is set to a GK3.

Comparing the length of the inter-vehicle time, the inter-vehicle time ST_GK1 is longer than the inter-vehicle time ST_GK2, and the inter-vehicle time ST_GK2 is longer than the inter-vehicle time ST_GK3. Comparing a magnitude relationship of the acceleration, the acceleration a_GK1 is larger than the acceleration a_GK2, and the acceleration a_GK2 is larger than the acceleration a_GK3.

The position (GK1, GK2, GK3) at which merging is actually performed is determined out of the candidate positions by the inter-vehicle time (ST_GK1, ST_GK2, ST_GK3), acceleration (a_GK1, a_GK2, a_GK3), and target position. The merging position is determined by various methods. For example, in a case where a difference between the inter-vehicle time (ST_GK1) with respect to the preceding vehicle 611 and the inter-vehicle time (STA) with respect to the target position is equal to or smaller than a predetermined value, and in a case where a difference between the inter-vehicle time (ST_GK2) with respect to the preceding vehicle 612 and the inter-vehicle time (ST_GK1) with respect to the preceding vehicle 611 is equal to or larger than a predetermined value, the merging position (GK2) is determined out of the candidate positions. In this manner, the merging position is determined to a position at which the difference in the inter-vehicle time between the target position and the preceding vehicle or the difference in the inter-vehicle time between the preceding vehicles is larger. Furthermore, in a case where the acceleration (a_GK1, a_GK2) determined on the basis of the merging position determined by the difference in the inter-vehicle time exceeds a predetermined value, the merging position is determined so as to have smaller acceleration (a_GK2, a_GK3).

The control device 410 determines the merging position (target merging position) at a position ahead of the preceding vehicle (for example, 611), and determines the target merging position in such a manner that the distance from the preceding vehicle increases as the speed of the preceding vehicle or the acceleration of the vehicle 1 (self-vehicle) increases. For example, in a case where there is a plurality of preceding vehicles (611, 612, 613), the control device 410 determines the target merging position at a position ahead of a leading preceding vehicle (preceding vehicle 611) located at the head out of the plurality of preceding vehicles, and determines the target merging position in such a manner that the distance from the leading preceding vehicle increases as the speed of the leading preceding vehicle (preceding vehicle 611) or the acceleration of the vehicle 1 increases.

In an example illustrated in 6B of FIG. 6, a road in which the self-vehicle traveling lane LN0 merges with another traveling lane LN1 is taken as an example of the traveling environment of the vehicle 1; however, in 6B of FIG. 6, a case where the vehicle 1 cannot merge at a mergeable position before arriving at a predetermined target position will be described.

The control device 410 controls the braking device (pressurization modulator 406) to decelerate the vehicle 1 in a case where it is not possible merge with another traveling lane LN1 before arriving at a predetermined target position. In the example illustrated in 6B of FIG. 6, the control device 410 determines a mergeable position (GK4) between the preceding vehicle 613 and a following vehicle 614 that travels in another traveling lane LN1, and controls the braking device to decelerate the vehicle 1 according to the determined position GK4. Assuming that acceleration for merging at the mergeable position GK4 is a_GK4, the acceleration a_GK4 is set to be lower than the acceleration a GK3 when merging at the third candidate position GK3 illustrated in 6A of FIG. 6. That is, the control device 410 performs the acceleration control in order for the vehicle 1 to merge at the mergeable candidate position (GK1, GK2, GK3) before arriving at a predetermined target position, and in a case where the vehicle 1 cannot merge at the mergeable position before arriving at a predetermined target position, this determines the position at which the vehicle 1 can merge (GK4) beyond a predetermined target position and controls the drive source so as to perform the deceleration control according to the determined position.

### Specific Example 2 of Driving Assistance Control

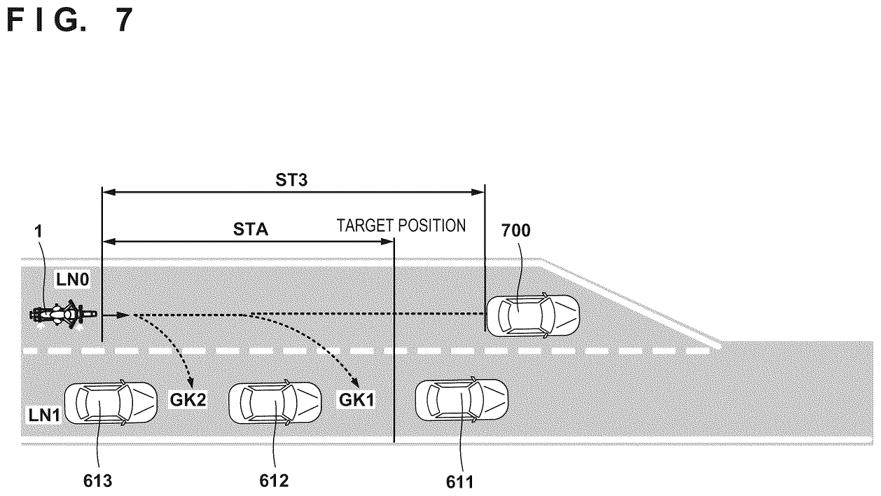

FIG. 7 is a diagram illustrating a specific example 2 of processing of a driving assistance device 400 according to the embodiment. In the example illustrated in FIG. 7, as a traveling environment of a vehicle 1, a road in which a traveling lane (self-vehicle traveling lane LN0) in which the vehicle 1 (self-vehicle) travels merges with another traveling lane LN1 will be described as an example. In the specific example 1 described with reference to FIG. 6, the example has been described in which the characteristic portion (wall surface EP1, terminal end EP2) in the self-vehicle traveling lane LN0 is acquired (extracted) and the target position is set on the basis of the inter-vehicle time with respect to the extracted characteristic portion. In the specific example 2, an example will be described in which, in a case where there is a preceding vehicle 700 of the vehicle 1 that travels in the self-vehicle traveling lane LN0, a target position of merging is set on the basis of an inter-vehicle time with respect to the preceding vehicle 700.

In FIG. 7, the vehicle 1 travels in the self-vehicle traveling lane LN0 at a predetermined vehicle speed set by ACC, and the preceding vehicle 700 travels ahead of the vehicle 1. The vehicle 1 is in a state of merging from the self-vehicle traveling lane LN0 with another traveling lane LN1. In another traveling lane LN1, a preceding vehicle 611 (first preceding vehicle), a preceding vehicle 612 (second preceding vehicle), and a preceding vehicle 613 (third preceding vehicle) travel.

A control device 410 acquires a position of a rear end of the preceding vehicle 700 (relative position with respect to the vehicle 1) on the basis of information of external environment detection sensors 9A to 9F. The control device 410 calculates an inter-vehicle time ST3 using information of a wheel speed sensor 401 and the position of the preceding vehicle 700. Setting of the target position in the specific example 2 is similar to that in the specific example 1.

In the specific example 2 illustrated in FIG. 7, the target position is set at a position closer to the vehicle 1 than the target position set in the specific example 1 (FIG. 6). Therefore, as illustrated in FIG. 6, a candidate position at which the vehicle 1 can merge is not set in a front position of the preceding vehicle 611 (first preceding vehicle). In the specific example 2 illustrated in FIG. 7, a first candidate position GK1 is an intermediate position between the preceding vehicle 611 (first preceding vehicle) and the preceding vehicle 612 (second preceding vehicle). The second candidate position GK2 is an intermediate position between the preceding vehicle 612 (second preceding vehicle) and the preceding vehicle 613 (third preceding vehicle).

In a case where a plurality of candidate positions is set, as in the case of the specific example 1 (FIG. 6), the control device 410 selects any one candidate position out of the plurality of candidate positions on the basis of a predetermined priority order, and controls a drive source 21 to accelerate the vehicle 1 according to the selected candidate position. For example, in a case where the plurality of candidate positions is set, the priority order can be set in order of proximity to a predetermined target position. For example, GK1 may be set to a first priority order, and GK2 may be set to a second priority order. Note that, in a case where there is one candidate position at which the vehicle 1 can merge, as in the specific example 1, the control device 410 may control the drive source 21 to accelerate the vehicle 1 according to the candidate position.

### (Flow of Processing by Driving Assistance Device 400)

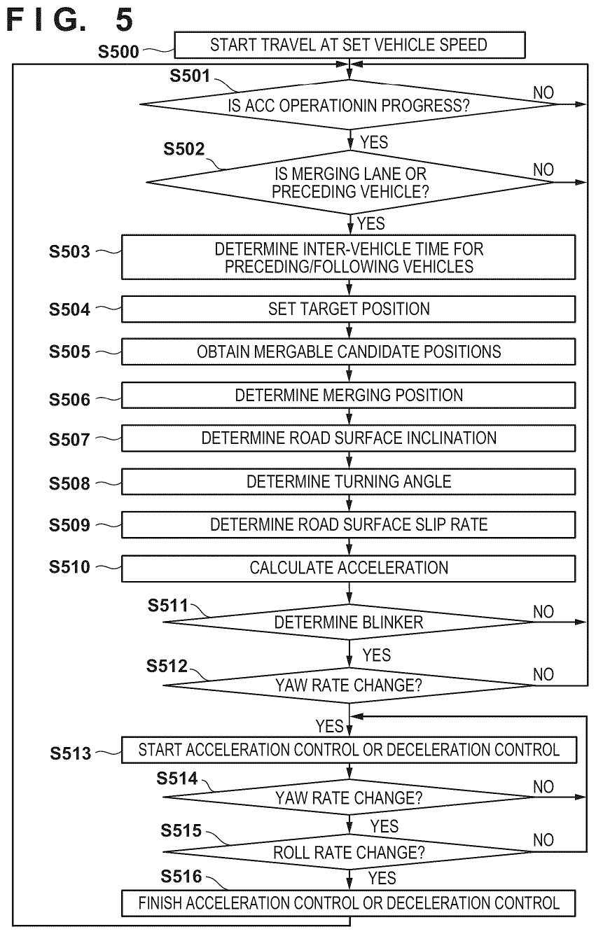

FIG. 5 illustrates a flow of processing of the driving assistance device 400 according to an embodiment.

At S501, the control device 410 starts travel of the vehicle 1 at a predetermined set speed. At S501, the control device 410 determines whether the ACC is in operation. In a case where the ACC is not in operation (NO at S501), determination processing at S501 is repeated. In contrast, in a case where the ACC is in operation in the determination at S501 (YES at S501), the processing proceeds to S502.

At S502, the control device 410 determines whether the self-vehicle traveling lane LN0 in which the vehicle 1 travels is a merging lane to merge with another traveling lane LN1 or whether there is another vehicle (for example, the preceding vehicle 700 in FIG. 7) ahead in the self-vehicle traveling lane LN0 on the basis of the information of the external environment detection sensors 9A to 9F. In a case where the self-vehicle traveling lane LN0 in which the vehicle 1 travels is not the merging lane and there is no preceding vehicle (No at S502), the processing returns to S501, and similar processing is repeated.

In contrast, in a case where it is determined at S502 that the self-vehicle traveling lane LN0 in which the vehicle 1 travels is the merging lane, or in a case where another vehicle (preceding vehicle 700) is present ahead in the self-vehicle traveling lane LN0 (YES at S502), the processing proceeds to S503.

At S503, the control device 410 determines presence or absence of the preceding vehicle and following vehicle on the basis of the information of the external environment detection sensors 9A to 9F. In a case where there is the preceding vehicle and following vehicle, the control device 410 acquires the inter-vehicle time of the preceding vehicle, and determines whether the inter-vehicle time regarding the preceding vehicle satisfies a set predetermined inter-vehicle time (for example, N1 seconds). Similarly, the control device 410 acquires the inter-vehicle time of the following vehicle, and determines whether the inter-vehicle time regarding the following vehicle satisfies a set predetermined inter-vehicle time (for example, N2 seconds) for each lane on the basis of the information of the external environment detection sensors 9A to 9F.

At S504, in a case where the self-vehicle traveling lane LN0 is the merging lane, the control device 410 sets a target position at which the merging of the vehicle 1 from the self-vehicle traveling lane LN0 to another traveling lane LN1 is finished. The setting of the target position is as described in the specific example 1 of FIG. 6 and the specific example 2 of FIG. 7.

At S505, the control device 410 acquires the inter-vehicle time regarding the preceding vehicle (for example, 611, 612, 613) of the vehicle 1 that travels in another traveling lane LN1 and the speed of the vehicle 1 on the basis of the information of the external environment detection sensors 9A to 9F, and determines (acquires) candidate positions (for example, GK1, GK2 and the like in FIGS. 6 and 7) at which the vehicle 1 can merge before arriving at the target position in a state in which a predetermined inter-vehicle time with respect to the preceding vehicle is maintained in another traveling lane LN1.

At S506, the control device 410 determines a merging position to merge out of the candidate positions acquired at S505. The control device 410 determines the merging position to merge out of the candidate positions on the basis of the inter-vehicle time (ST_GK1, ST_GK2, ST_GK3) with respect to the preceding vehicle, acceleration (a_GK1, a_GK2, a_GK3) of the preceding vehicle, and the target position set at S504. Note that, the control device 410 can determine the merging position by various methods on the basis of the inter-vehicle time with respect to the preceding vehicle, the acceleration of the preceding vehicle, and the target position. In a case where a plurality of candidate positions is mergeable positions, the merging position may be determined out of the plurality of candidate positions according to a priority order set in advance.

At S507, the control device 410 acquires an inclination angle of a road surface on which the vehicle 1 travels on the basis of the information detected by the external environment detection sensors 9A to 9F or an inertial measurement sensor unit 403, and determines whether the acquired inclination angle of the road surface exceeds a predetermined threshold inclination angle. The control device 410 changes setting of the acceleration when merging with another lane when overtaking the preceding vehicle 600 on the basis of a determination result of the road surface inclination angle. The control device 410 sets the acceleration for merging with another traveling lane larger in a case where the inclination angle acquired from the sensor is equal to or larger than a predetermined threshold inclination angle as compared with the setting of the acceleration in a case where the inclination angle of the road surface is smaller than the predetermined threshold inclination angle (for example, a rising gradient of +5%) (for example, 1.5 times). The control device 410 sets the acceleration for merging with another traveling lane smaller in a case where the inclination angle acquired from the sensor is smaller than a predetermined threshold inclination angle as compared with the setting of the acceleration in a case where the inclination angle of the road surface is equal to or larger than the predetermined threshold inclination angle (for example, a falling gradient of −5%) (for example, 0.5 times).

At S508, the control device 410 acquires a roll angle (turning angle) of the vehicle 1 on the basis of the information detected by the inertial measurement sensor unit 403, and determines whether the acquired roll angle exceeds a predetermined threshold roll angle (threshold turning angle). The control device 410 determines whether acceleration control is possible on the basis of a determination result of the roll angle (turning angle). In a case where the roll angle of the vehicle 1 acquired on the basis of the information detected by the inertial measurement sensor unit 403 is equal to or larger than a predetermined threshold roll angle (threshold turning angle), the control device 410 does not perform the acceleration control for merging with another traveling lane.

In contrast, in a case where the roll angle of the vehicle 1 is smaller than the predetermined threshold roll angle (threshold turning angle), the control device 410 changes the setting in such a manner that the acceleration when moving to another lane (changing lane) when overtaking the preceding vehicle 600 increases as the roll angle decreases. The predetermined threshold roll angle (threshold turning angle) for determining the roll angle is different on the left and right of a vehicle width of the vehicle 1. For example, in a case where the vehicle 1 turns to the right as the turning direction, the external environment detection sensor (for example, 9B, 9D in FIG. 3) of which detection range is the right side (diagonally forward right, right lateral side, diagonally rearward right) of the vehicle 1 is in a state of being inclined to the road surface side as compared with the external environment detection sensor (for example, 9C, 9E in FIG. 3) of which detection range is the left side (diagonally forward left, left lateral side, diagonally rearward left) of the vehicle 1, and the external environment detection sensor (9B, 9D) in a state of being inclined to the road surface side detects the road surface on the right side of the vehicle 1. In such a traveling state, the detection range of the external environment detection sensor (9B, 9D in FIG. 3) that detects the right side of the vehicle 1 might be narrower than the detection range of the external environment detection sensor (for example, 9C, 9E in FIG. 3) of which detection range is the left side of the vehicle 1. That is, the detection range of the external environment detection sensor on the turning direction side might be narrower than the detection range of the external environment detection sensor on the side opposite to the turning direction (non-turning direction). It is preferable to set different threshold roll angles (threshold turning angles) on the left and right sides of the vehicle width of the vehicle 1 corresponding to the turning direction of the vehicle so that a predetermined detection range can be secured in such a manner that a difference does not occur between the left and right detection ranges depending on the turning direction in which the vehicle 1 turns. In a case where the vehicle 1 turns right, the detection range on the right side of the vehicle 1 can be widened by setting the right threshold roll angle of the vehicle 1 to be smaller than the left threshold roll angle of the vehicle 1. For example, when turning right, the right threshold roll angle of the vehicle 1 may be set to 10 degrees, and the left threshold roll angle of the vehicle 1 may be set to 15 degrees. Similarly, in a case where the vehicle 1 turns left, the left and right threshold roll angles may be set differently in order to suppress occurrence of an area that cannot be detected by the external environment detection sensor on the left side of the vehicle 1 in the detection range of the external environment detection sensors 9A to 9F. In this manner, by setting different threshold roll angles (threshold turning angles) on the left and right sides of the vehicle width of the vehicle 1 corresponding to the turning direction of the vehicle, it is possible to suppress occurrence of difference in the left and detection ranges depending on the turning direction in which the vehicle 1 turns, and secure a predetermined detection range in such a manner that a difference does not occur between the left and right detection ranges depending on the turning direction in which the vehicle 1 turns.

At S509, the control device 410 acquires a slip rate of a road surface on which the vehicle 1 travels on the basis of the information detected by the external environment detection sensors 9A to 9F or the wheel speed sensor 401, and determines whether the acquired slip rate of the road surface exceeds a predetermined threshold slip rate. The control device 410 changes setting of the acceleration when merging with another lane when overtaking the preceding vehicle 600 on the basis of a determination result of the slip rate of the road surface. Here, the slip rate can be calculated by various known methods, and can be obtained, for example, by dividing a difference (V1−V2) between the vehicle speed V1 and the wheel speed V2 by the vehicle speed V1. A case where the slip rate is 0% indicates a state in which the wheel speed and the vehicle speed (vehicle body speed) are equal, and a state in which the wheel rolls on the road surface without being locked.

For example, in a case where the slip rate on the road surface is equal to or larger than a predetermined first threshold slip rate (for example, 10%), the control device 410 does not perform the acceleration control for merging with another traveling lane. The control device 410 sets the first acceleration in a case where the slip rate is smaller than a second threshold slip rate (for example, 5%) smaller than the first threshold slip rate. Then, in a case where the slip rate is the second threshold slip rate (for example, 5%) or larger and smaller than the first threshold slip rate (for example, 10%), the control device 410 sets the second acceleration smaller than the acceleration of the first acceleration (for example, the second acceleration=0.5×first acceleration).

At S510, the control device 410 calculates the acceleration in the acceleration control. The control device 410 calculates the acceleration in the acceleration control in consideration of various conditions at S503 to S509. Note that, not all of the various conditions at S503 to S509 are essential conditions, and the control device 410 can perform the acceleration control for merging from the self-vehicle traveling lane LN0 to another traveling lane LN1 by considering at least the conditions at S503 to S505 out of S503 to S509.

At S511, the control device 410 determines whether a blinker operation has been performed (blinker determination). In a case where the blinker operation of the vehicle 1 is not yet input (NO at S511), the processing returns to S501, and the control device 410 repeats similar processing after S501.

In contrast, in a case where it is determined at S511 that the blinker operation of the vehicle 1 is input (YES at S511), the processing proceeds to S512.

At S512, on the basis of the information of the inertial measurement sensor unit 403, the control device 410 determines whether a change in posture (for example, the yaw rate) of the vehicle 1 merging from the self-vehicle traveling lane LN0 of the vehicle 1 with another traveling lane is measured exceeding a threshold (posture change threshold, for example, 20 deg/s). In a case where the change in posture (yaw rate) of the vehicle 1 does not exceed the threshold (No at S512), the processing returns to S501, and the control device 410 repeats similar processing after S501.

In contrast, in a case where it is determined at S512 that the change in posture (yaw rate) of the vehicle 1 exceeds the threshold (YES at S512), the processing proceeds to S513.

At S513, the control device 410 starts the acceleration control or deceleration control (merging assist) for merging with another lane. The control device 410 executes the acceleration control or deceleration control (merging assist) on the basis of the acceleration calculated at S510. A case of performing the acceleration control is a case described with reference to 6A of FIG. 6 or FIG. 7, and a case of performing the deceleration control is a case described with reference to 6B of FIG. 6. That is, in a case where the vehicle 1 cannot merge at the mergeable position before arriving at a predetermined target position, the control device 410 determines a position at which the vehicle 1 can merge (GK4) beyond a predetermined target position and controls the drive source so as to perform the deceleration control according to the determined position.

At S514, on the basis of the information of the inertial measurement sensor unit 403, the control device 410 determines whether a change in posture (for example, the yaw rate) of the vehicle 1 for determining finish of merging from the self-vehicle traveling lane LN0 with another traveling lane LN1 is measured exceeding a first merging finishing threshold (for example, −15 deg/s). In a case where the change in posture of the vehicle 1 does not exceed the first merging finishing threshold (NO at S514), the processing returns to S513, and the acceleration control or the deceleration control is continued (S513).

In contrast, in a case where it is determined at S514 that the change in posture (for example, the yaw rate) of the vehicle 1 exceeds the first merging finishing threshold (YES at S514), the processing proceeds to S515.

At S515, on the basis of the information of the inertial measurement sensor unit 403, the control device 410 determines whether a change in posture (for example, the roll rate) of the vehicle 1 for determining finish of merging from the self-vehicle traveling lane LN0 with another traveling lane LN1 is measured exceeding a second merging finishing threshold (for example, −15 deg/s). In a case where the change in posture of the vehicle 1 does not exceed the second merging finishing threshold (NO at S515), the processing returns to S513, and the acceleration control or the deceleration control is continued (S513).

In contrast, in a case where it is determined at S515 that the change in posture (for example, the roll rate) of the vehicle 1 exceeds the second merging finishing threshold (YES at S515), the processing proceeds to S516.

At S516, the control device 410 finishes the acceleration control or deceleration control (merging assist). Thereafter, the processing returns to S501, and the processing after S501 is similarly executed.

### Summary of Embodiments

(Item 1) The driving assistance device (400) according to the embodiments comprises: an external environment detection sensor (9A-9F) of a vehicle; and a controller (410) configured to control a drive source of the vehicle, wherein the controller controls the drive source so as to change acceleration of the vehicle on the basis of relative information including at least any one of an arrival time, a distance, or a relative speed with respect to a predetermined position ahead or another vehicle ahead in a self-vehicle traveling lane in which the vehicle travels, and a traveling status in another traveling lane as a merging destination on the basis of information of the external environment detection sensor.

According to the driving assistance device according to item 1, in the traveling environment in which the traveling lane of the self-vehicle merges with another traveling lane, acceleration of the vehicle can be changed according to the mergeable position determined according to the situation of another traveling lane as the merging destination.

(Item 2) The driving assistance device (400) further comprises: a wheel speed sensor (401) configured to detect a speed of the vehicle; and
an inertial measurement sensor (403) configured to measure a posture of the vehicle, wherein
the controller (410)
controls the drive source of the vehicle using information acquired by the external environment detection sensor, the wheel speed sensor, and the inertial measurement sensor,
determines whether the self-vehicle traveling lane in which the vehicle travels is a merging lane that merges with another traveling lane or whether there is another vehicle ahead in the self-vehicle traveling lane on the basis of the information of the external environment detection sensor,
sets a target position on the basis of relative information including at least any one of an inter-vehicle time, an inter-vehicle distance, and a relative speed with respect to a predetermined position in the merging lane or relative information including at least any one of an inter-vehicle time, an inter-vehicle distance, and a relative speed with respect to the another vehicle in a case where the self-vehicle traveling lane is the merging lane or a case where there is the another vehicle,
determines a position at which the vehicle can merge before arriving at the target position in the another traveling lane on the basis of relative information including at least any one of an inter-vehicle time, an inter-vehicle distance, or a relative speed with respect to a preceding vehicle of the vehicle that travels in the another traveling lane acquired from the information of the external environment detection sensor, and
controls the drive source so as to change the acceleration of the vehicle according to the determined position.

According to the driving assistance device according to item 2, in the traveling environment in which the traveling lane of the self-vehicle merges with another traveling lane, acceleration of the vehicle can be changed according to the mergeable position determined according to the situation of another traveling lane as the merging destination.

(Item 3) The controller (410) compares the inter-vehicle time of the preceding vehicle with a predetermined time, and sets the acceleration in a case where the inter-vehicle time is shorter than the predetermined time lower than the acceleration set in a case where the inter-vehicle time is longer than the predetermined time.

According to the driving assistance device according to item 3, when the vehicle (self-vehicle) merges from the self-vehicle traveling lane (merging lane) to another traveling lane (adjacent lane), in a case where the vehicle cannot merge on the front side of the preceding vehicle at a long distance that travels in another traveling lane and merges on the rear side of the preceding vehicle at a short distance, the acceleration is set to be low. Therefore, it is possible to secure the inter-vehicle time between the vehicle (self-vehicle) and the preceding vehicle after the merging, and to merge by acceleration control while suppressing anxiety of the rider.

(Item 4) The controller (410) controls the drive source by changing a setting in such a manner that the acceleration of the vehicle increases as the inter-vehicle time increases.

According to the driving assistance device according to item 4, when the vehicle (self-vehicle) merges from the self-vehicle traveling lane (merging lane) to another traveling lane (adjacent lane), in a case where the vehicle can merge on the front side of the preceding vehicle at a long distance, the acceleration is set to be large. Therefore, it is possible to merge at sufficient acceleration, and the inter-vehicle time between the vehicle (self-vehicle) and the preceding vehicle after merging can be secured.

(Item 5) The controller (410) controls a braking means of the vehicle so as to decelerate the vehicle in a case where it is not possible to merge with the another traveling lane before the target position.

According to the driving assistance device according to item 5, in a case where it is not possible to merge with another traveling lane before the target position, it is possible to suppress anxiety of the rider by avoiding the acceleration control immediately before merging and merging by the deceleration control.

(Item 6) In a case where there is a first preceding vehicle and a second preceding vehicle following the first preceding vehicle as a plurality of preceding vehicles that travel in the another traveling lane, the controller (410) determines a mergeable second position between the first preceding vehicle and the second preceding vehicle, and controls the drive source so as to change the acceleration of the vehicle according to the determined second position.

According to the driving assistance device according to item 6, in a case where there is a plurality of preceding vehicles, the acceleration of the vehicle can be changed according to not only a distance to one preceding vehicle but also the mergeable position (second position) determined between the vehicle on the front side and the vehicle on the rear side out of the plurality of preceding vehicles. This makes it possible to assist the change in acceleration so that the merging at a more appropriate position is possible between the vehicle on the front side and the vehicle on the rear side.

(Item 7) The controller (410) controls the drive source in a case where a blinker operation is input and a change in posture of the vehicle that merges from the self-vehicle traveling lane with another traveling lane is measured exceeding a threshold on the basis of the information of the inertial measurement sensor.

(Item 8) In the driving assistance device, information indicating the change in posture of the vehicle includes a yaw rate or a roll rate of the vehicle acquired on the basis of a measurement result of the inertial measurement sensor, and the controller (410) controls the drive source in a case where the yaw rate or the roll rate exceeds the threshold.

According to the driving assistance device according to items 7 and 8, it is possible to assist the merging of the vehicle by reflecting an intention of the rider to merge.

(Item 9) The controller (410) sets the target position at a position ahead of the preceding vehicle, and sets the target position in such a manner that a distance between the preceding vehicle and the target position increases as a speed of the preceding vehicle or the acceleration of the vehicle increases.

(Item 10) In a case where there is a plurality of preceding vehicles, the controller (410) sets the target position at a position ahead of a head preceding vehicle located at the head of the plurality of preceding vehicles, and sets the target position in such a manner that a distance between the head preceding vehicle and the target position increases as a speed of the head preceding vehicle or the acceleration of the vehicle increases.

According to the driving assistance device according to items 9 and 10, the distance between the preceding vehicle and the target position can be adjusted according to the speed of the preceding vehicle and the acceleration of the vehicle (self-vehicle), and the distance from the preceding vehicle is secured, so that it is possible to merge by the acceleration control while suppressing the anxiety of the rider.

(Item 11) A driving assistance method of a driving assistance device including an external environment detection sensor (9A-9F) of a vehicle, and a controller (410) configured to control a drive source of the vehicle, the method comprises:
controlling the drive source so as to change acceleration of the vehicle on the basis of relative information including at least any one of an arrival time, a distance, or a relative speed with respect to a predetermined position ahead or another vehicle ahead in a self-vehicle traveling lane in which the vehicle travels, and a traveling status in another traveling lane as a merging destination on the basis of information of the external environment detection sensor performed by the controller.

According to the driving assistance method according to item 11, in the traveling environment in which the traveling lane of the self-vehicle merges with another traveling lane, acceleration of the vehicle can be changed according to the mergeable position determined according to the situation of another traveling lane as the merging destination.

The invention is not limited to the foregoing embodiments, and various variations/changes are possible within the spirit of the invention.

What is claimed is:

1. A driving assistance device comprising: an external environment detection sensor of a vehicle; and a controller configured to control a drive source of the vehicle, wherein the controller
controls the drive source so as to change acceleration of the vehicle on the basis of relative information including at least any one of an arrival time, a distance, or a relative speed with respect to a predetermined position ahead or another vehicle ahead in a self-vehicle traveling lane in which the vehicle travels, and a traveling status in another traveling lane as a merging destination on the basis of information of the external environment detection sensor.

2. The driving assistance device according to claim 1, further comprising: a wheel speed sensor configured to detect a speed of the vehicle; and
an inertial measurement sensor configured to measure a posture of the vehicle, wherein
the controller
controls the drive source of the vehicle using information acquired by the external environment detection sensor, the wheel speed sensor, and the inertial measurement sensor,
determines whether the self-vehicle traveling lane in which the vehicle travels is a merging lane that merges with another traveling lane or whether there is another vehicle ahead in the self-vehicle traveling lane on the basis of the information of the external environment detection sensor,
sets a target position on the basis of relative information including at least any one of an inter-vehicle time, an inter-vehicle distance, and a relative speed with respect to a predetermined position in the merging lane or relative information including at least any one of an inter-vehicle time, an inter-vehicle distance, and a relative speed with respect to the another vehicle in a case where the self-vehicle traveling lane is the merging lane or a case where there is the another vehicle,
determines a position at which the vehicle can merge before arriving at the target position in the another traveling lane on the basis of relative information including at least any one of an inter-vehicle time, an inter-vehicle distance, or a relative speed with respect to a preceding vehicle of the vehicle that travels in the another traveling lane acquired from the information of the external environment detection sensor, and
controls the drive source so as to change the acceleration of the vehicle according to the determined position.

3. The driving assistance device according to claim 2, wherein the controller compares the inter-vehicle time of the preceding vehicle with a predetermined time, and
sets the acceleration in a case where the inter-vehicle time is shorter than the predetermined time lower than the acceleration set in a case where the inter-vehicle time is longer than the predetermined time.

4. The driving assistance device according to claim 2, wherein the controller controls the drive source by changing a setting in such a manner that the acceleration of the vehicle increases as the inter-vehicle time increases.

5. The driving assistance device according to claim 2, wherein the controller controls a braking means of the vehicle so as to decelerate the vehicle in a case where it is not possible to merge with the another traveling lane before the target position.

6. The driving assistance device according to claim 2, wherein, in a case where there is a first preceding vehicle and a second preceding vehicle following the first preceding vehicle as a plurality of preceding vehicles that travel in the another traveling lane, the controller determines a mergeable second position between the first preceding vehicle and the second preceding vehicle, and controls the drive source so as to change the acceleration of the vehicle according to the determined second position.

7. The driving assistance device according to claim 2, wherein the controller controls the drive source in a case where a blinker operation is input and a change in posture of the vehicle that merges from the self-vehicle traveling lane with another traveling lane is measured exceeding a threshold on the basis of the information of the inertial measurement sensor.

8. The driving assistance device according to claim 7, wherein information indicating the change in posture of the vehicle includes a yaw rate or a roll rate of the vehicle acquired on the basis of a measurement result of the inertial measurement sensor, and
the controller
controls the drive source in a case where the yaw rate or the roll rate exceeds the threshold.

9. The driving assistance device according to claim 2, wherein the controller sets the target position at a position ahead of the preceding vehicle, and sets the target position in such a manner that a distance between the preceding vehicle and the target position increases as a speed of the preceding vehicle or the acceleration of the vehicle increases.

10. The driving assistance device according to claim 2, wherein, in a case where there is a plurality of preceding vehicles, the controller sets the target position at a position ahead of a head preceding vehicle located at the head of the plurality of preceding vehicles, and
sets the target position in such a manner that a distance between the head preceding vehicle and the target position increases as a speed of the head preceding vehicle or the acceleration of the vehicle increases.

11. A driving assistance method of a driving assistance device including an external environment detection sensor of a vehicle, and a controller configured to control a drive source of the vehicle,
the method comprising:
controlling the drive source so as to change acceleration of the vehicle on the basis of relative information including at least any one of an arrival time, a distance, or a relative speed with respect to a predetermined position ahead or another vehicle ahead in a self-vehicle traveling lane in which the vehicle travels, and a traveling status in another traveling lane as a merging destination on the basis of information of the external environment detection sensor performed by the controller.
